(19) United States
(12) Patent Application Publication
(10) Pub. No.: US 2011/0049316 A1
(43) Pub. Date: Mar. 3, 2011

(54) HINGE FOR TONNEAU COVER AND MOUNTING ASSEMBLY

(75) Inventors: Ekawat VITOORAPAKORN, Nikompattana Minor District (TH); Supawadee VITOORAPAKORN, Bangplee District (TH)

(73) Assignee: AEROKLAS COMPANY LIMITED, Rayong (TH)

(21) Appl. No.: 12/868,813

(22) Filed: Aug. 26, 2010

(30) Foreign Application Priority Data
Aug. 26, 2009 (TH) 0903000933

(51) Int. Cl. E05D 7/00; F16M 13/02

(52) U.S. Cl. 248/226.11; 16/223

(57) ABSTRACT

A hinge for a tonneau cover and a mounting assembly includes a right hinge, a left hinge, four connectors, a first clamping device, and a second clamping device. The first clamping device is attached to the right edge of the truck bed, while the second clamping device is attached to the left edge of the truck bed. The right hinge includes an upper plate, a front plate, a downward plate, and a lateral plate. The left hinge includes an upper plate, a front plate, a downward plate, and a lateral plate. The hinge for the tonneau cover and the mounting assembly can be mounted without drilling the truck bed and is compatible with various models of pickup trucks and can be mounted in the pickup trucks with or without the bed liner.

### BACKGROUND OF THE INVENTION

The present invention relates to a hinge for a tonneau cover and a mounting assembly.

It has become more common nowadays that pickup truck users mount a tonneau cover over the truck bed of their pickup truck to protect the carried cargoes from the environment, such as rain, dust, etc. There are many types of tonneau covers available in the market, for example, fiber-glass tonneau covers and twin sheet plastic tonneau covers molded by the vacuum thermoforming process. The hinge for the tonneau cover and the mounting assembly has already been known from the U.S. Pat. No. 6,109,681 by Edwards et al. The hinge according to the Edwards patent uses a beam in mounting the hinge. The length of the beam covers the distance from the left truck bed wall to the right truck bed wall. This is a waste of material and results in the increase in the manufacturing cost. In addition, the beam is of the fixed length for one model of a pickup truck and is, therefore, not compatible with another model of which width is different. It is, therefore, necessary to provide a hinge for the tonneau cover and the mounting assembly that can eliminate these aforementioned drawbacks.

### BRIEF SUMMARY OF THE INVENTION

The hinge for the tonneau cover and the mounting assembly according to the present invention comprises a right hinge, a left hinge, four connectors, a first clamping device, and a second clamping device. The first clamping device is attached to the right edge of the truck bed, while the second clamping device is attached to the left edge of the truck bed. The first two connectors are attached to the first clamping device, while the remaining two connectors are attached to the second clamping device. The right hinge comprises an upper plate having the first end and the second end, wherein the first end is attached to the tonneau cover, the second end is rotatably attached to the first end of the front plate. The front plate having the first end and the second end, wherein the first end is rotatably attached to the upper plate, the second end includes the downward plate extending therefrom, wherein during the mounting the first end rests over the upper edge of front truck bed wall. The downward plate extends from the front plate in the downward direction, at the right edge of the downward plate includes a lateral plate extending therefrom. A lateral plate extends from the downward plate in the direction toward the rear end of the truck after being assembled, wherein the lateral plate is attached to the two connectors that have been attached to the first clamping device. The left hinge comprises the upper plate having the first end and the second end, wherein the first end is attached to the tonneau cover, the second end is rotatably attached to the first end of the front plate. The front plate has the first end and the second end, wherein the first end is rotatably attached to the upper plate, the second end includes the downward plate extending therefrom, wherein during the mounting the first end rests over the upper edge of front truck bed wall. The downward plate extending from the front plate in the downward direction, at the left edge of the downward plate includes a lateral plate extending therefrom. The lateral plate extends from the downward plate in the direction toward the rear end of the truck after being assembled, wherein the lateral plate is attached to the two connectors that have been attached to the second clamping device.

One object of the present invention is to provide the hinge for the tonneau cover and mounting assembly having a mounting means without drilling the truck bed.

Another object of the present invention is to provide the hinge for the tonneau cover and mounting assembly having low cost of manufacturing and being compatible with various models of pickup trucks.

Yet another object of the present invention is to provide the hinge for the tonneau cover and mounting assembly that can be mounted in the pickup trucks with or without the bed liner.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a portion of a truck bed of a pickup truck in accordance with a preferred embodiment of the present invention;

FIG. 2 is a sectional view from the line 2-2 in FIG. 1 of an upper edge of a right truck bed wall;

FIG. 3 is a perspective view of a right hinge and a mounting assembly according to a preferred embodiment of the present invention;

FIG. 4 is a perspective view of a left hinge and the mounting assembly according to a preferred embodiment of the present invention;

FIG. 5 is a perspective view of holes at a right bed liner wall;

FIG. 6 is a perspective view of a first clamping device that has already been mounted to the upper edge of the right truck bed wall;

FIG. 7 is the sectional view from the line 7-7 in FIG. 1 of the right hinge mounted to the truck bed that has already been mounted with the bed liner;

FIG. 8 is the sectional view from the line 7-7 in FIG. 1 of the right hinge mounted to the truck bed without bed liner;

FIG. 9 is the sectional view from the line 7-7 in FIG. 1 of the right hinge mounted to the truck bed mounted with the bed liner as indicated by the solid line in comparison with the right hinge mounted to the truck bed without the bed liner as indicated by the dotted line; and

FIG. 10 is a sectional view from the line 2-2 in FIG. 1 of the right hinge mounted to the truck bed that has already been mounted with the bed liner.

### DETAILED DESCRIPTION OF THE INVENTION

Certain terminology is used in the following description for convenience only and is not limiting. The words “right,” “left,” “lower,” “upper,” “front” and “rear” designate directions in the drawings to which reference is made. The word “inwardly” refers to a direction toward the geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

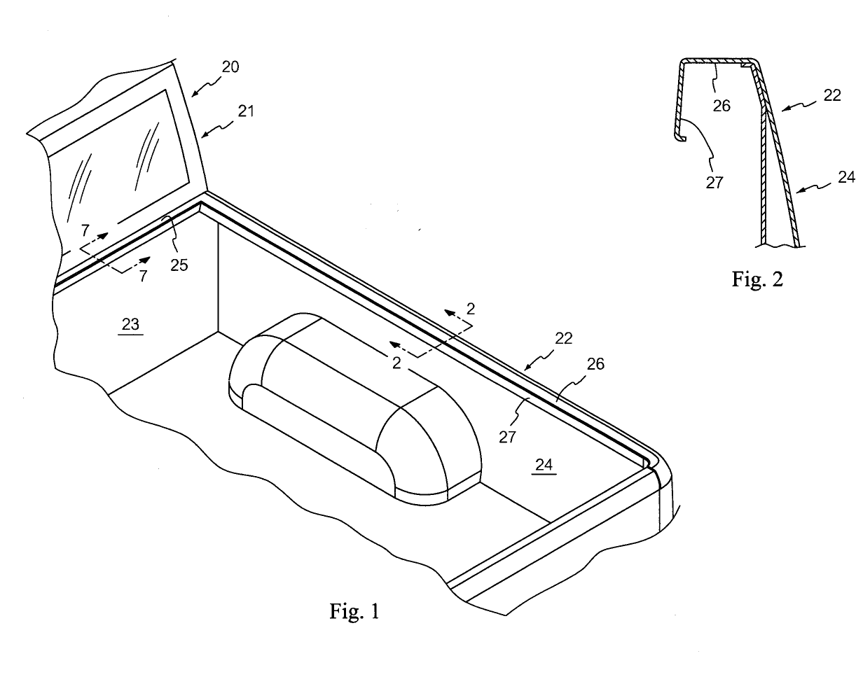

Referring to the drawings in detail, wherein like numerals indicate like elements throughout the several views, FIG. 1 shows a pickup truck 20 according to a preferred embodiment of the present invention. The pickup truck 20 preferably includes a passenger cabin 21, a truck bed 22, a front truck bed wall 23, a right truck bed wall 24, an upper edge 25 of front truck bed wall, a horizontal edge 26 of the right truck bed wall and a downward edge 27 of the right truck bed wall. FIG. 2 shows an enlarged view of the horizontal edge 26 and the downward edge 27.

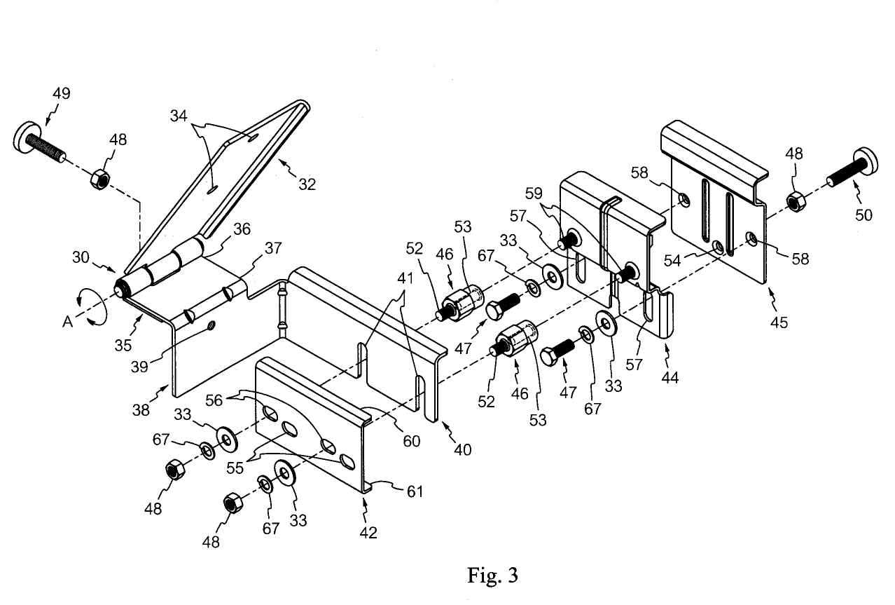

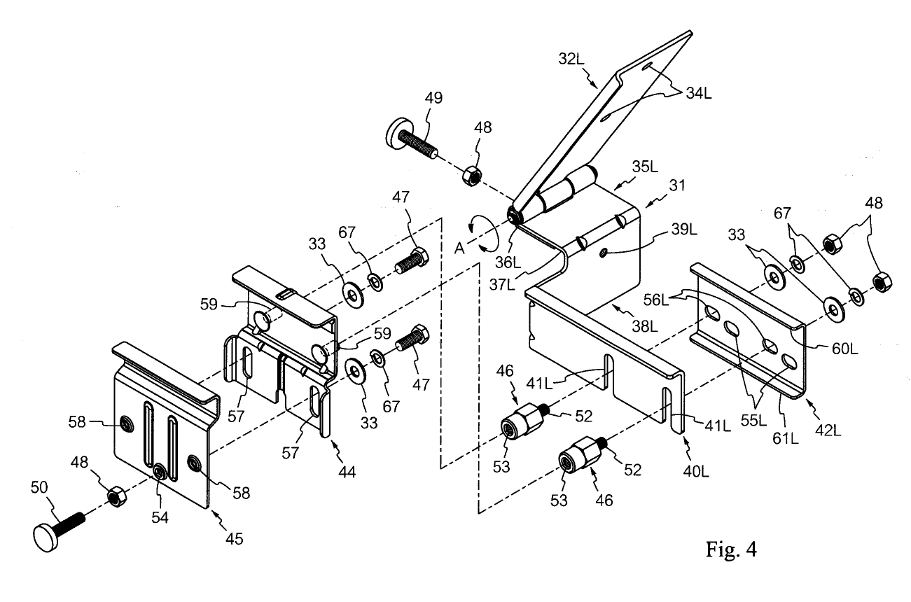

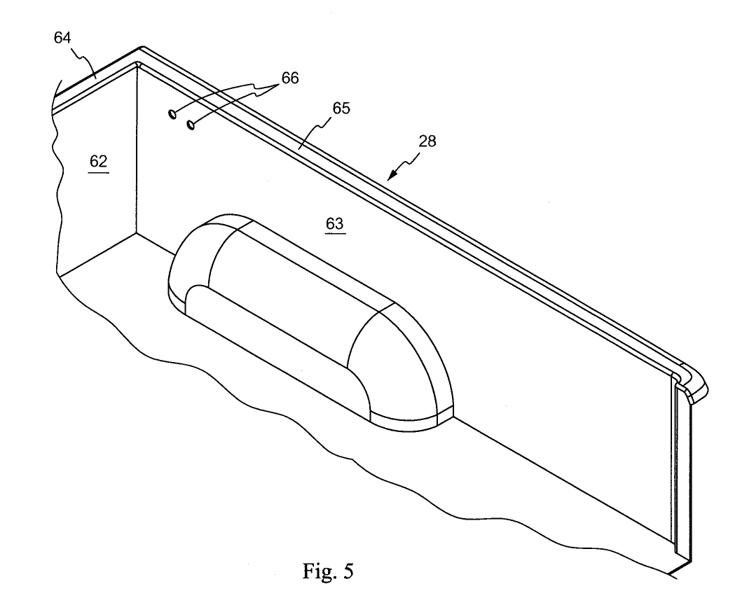

The hinge for the tonneau cover and mounting assembly according to the a preferred embodiment of the present invention comprises a right hinge 30 as shown in FIG. 3, a left hinge 31 as shown in FIG. 4, four connectors 46, a first clamping device and a second clamping device. The first clamping device is attached to the right edge of the truck bed 22, while the second clamping device is attached to the left edge of the truck bed 22. The first two connectors 46 are attached to the first clamping device and the remaining two connectors 46 are attached to the second clamping device.

FIG. 3 shows the right hinge 30 comprising an upper plate 32, a front plate 35, a downward plate 38, and the lateral plate 40 as explained in detail below. The upper plate 32 includes a first end and a second end, wherein the first end is attached to the tonneau cover 29 and the second end is rotatably attached to the first end 36 of the front plate 35 with a rotating axis A acting as the a rotating axis of the hinge. The front plate 35 includes a first end 36 and a second end 37, wherein the first end 36 is rotatably attached to the upper plate 32 and the second end 37 includes the downward plate 38 extending therefrom, wherein during the mounting the first end 36 rests over the upper edge 25 of front truck bed wall. The downward plate 38 extends from the front plate 35 in the downward direction, at the right edge of the downward plate includes a lateral plate 40 extending therefrom, and the lateral plate 40 extending from the downward plate 38 in the direction toward the rear end of the truck after being assembled, wherein the lateral plate 40 is attached to the two connectors 46 that have been attached to the first clamping device.

FIG. 4 shows the left hinge 31 comprising an upper plate 32L, a front plate 35L, a downward plate 38L, and a lateral plate 40L to be later described. The upper plate 32L includes a first end and a second end, wherein the first end is attached to the tonneau cover 29 and the second end is rotatably attached to the first end 36L of the front plate 35L with a rotating axis A acting as the a rotating axis of the hinge. The front plate 35L includes a first end 36L and a second end 37L, wherein the first end 36L is rotatably attached to the upper plate 32L and the second end 37L includes the downward plate 38L extending therefrom, wherein during the mounting the first end 36L rests over the upper edge 25 of front truck bed wall. The downward plate 38L extends from the front plate 35L in the downward direction, at the left edge of the downward plate includes a lateral plate 40L extending therefrom, and the lateral plate 40L extending from the downward plate 38L in the direction toward the rear end of the truck after being assembled, wherein the lateral plate 40L is attached to the two connectors 46 that have been attached to the second clamping device.

From the above description, those of ordinary skills in the art will appreciate that the hinge for the tonneau cover 29 and mounting assembly according to the present invention can be mounted without drilling the truck bed 22 due to the use of the clamping device in the mounting and compatible with various models since the right hinge 30 and the left hinge 31 are separated. These devices can, therefore, be mounted to pickup trucks 20 having different widths of the truck bed 22.

The mounting assembly further comprises a bracket 49 for use with the right hinge 30 as shown in FIG. 3. The bracket 49 is adjustably attached to the downward plate 38 of the right hinge 30. During the mounting, one end of the bracket 49 will be in the position abutting the front truck bed wall 23 to prevent the right hinge 30 from moving to the front of the truck bed 22 when the user opens/closes the tonneau cover 29. The abutting distance of the bracket 49 is adjustable by inserting the threaded shaft of the bracket through the nut 48. The bracket 49 is then fastened into the threaded hole 39. After the bracket 49 is fastened to the proper abutting distance, the nut 48 is then tightened.

The mounting assembly further comprises a bracket 49 for use with the left hinge 31 as shown in FIG. 4. The bracket 49 is adjustably attached to the downward plate 38L of the left hinge 31. During the mounting, one end of the bracket 49 will be in the position abutting the front truck bed wall 23 to prevent the left hinge 31 from moving to the front of the truck bed 22 when the user opens/closes the tonneau cover 29. The abutting distance of the bracket 49 is adjustable by inserting the threaded shaft of the bracket through the nut 48. The bracket 49 is then fastened into the threaded hole 39L. After the bracket 49 is fastened to the proper abutting distance, the nut 48 is then tightened.

In addition, the present invention also provides other components as described below to be mounted in the pickup truck with or without the bed liner. Specifically, the lateral plate 40 of the right hinge 30, as shown in FIG. 3, includes two notches 41, wherein those notches 41 extend from the lower edge of the lateral plate 40. This allows the installer to mount the notch 41 to the threaded shaft 52 by sliding the lateral plate 40 in the downward direction to couple the notch 41 to the threaded shaft 52. The lateral plate 40L of the left hinge 31, as shown in FIG. 4, includes two notches 41L, wherein those notches 41L extend from the lower edge of the lateral plate 40L.

The outer plate 44 of the first clamping device, as shown in FIG. 3 includes two threaded shafts 59. The first clamping device is attached to the right edge of the truck bed by screwing the bolt 47 until the inner plate 45 exerts the force onto the outer plate 44 with the downward edge 27 of the truck bed resting therebetween. The outer plate 44 of the second clamping device, as shown in FIG. 4, includes two threaded shaft 59. The second clamping device is attached to the left edge of the truck bed by screwing the bolt 47 until the inner plate 45 exerts the force onto the outer plate 44 with the downward edge of truck bed resting therebetween. Each connector 46 comprises two ends, as shown in FIGS. 3 and 4. One end is the threaded shaft 52 and the other end includes the threaded hole 53. During the mounting, the threaded hole 53 of the connector 46 is fastened to the threaded shaft 59 of the outer plate 44.

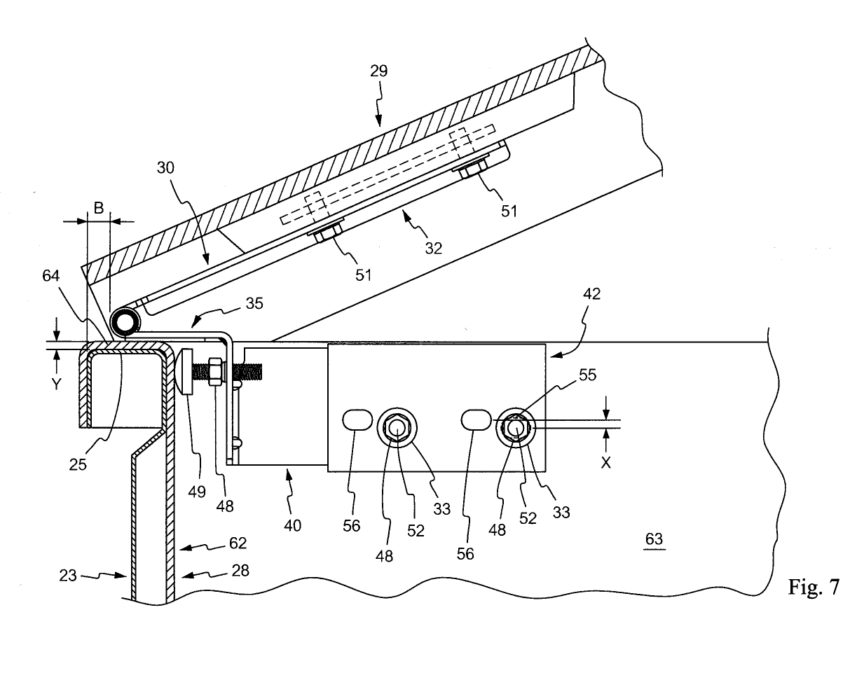

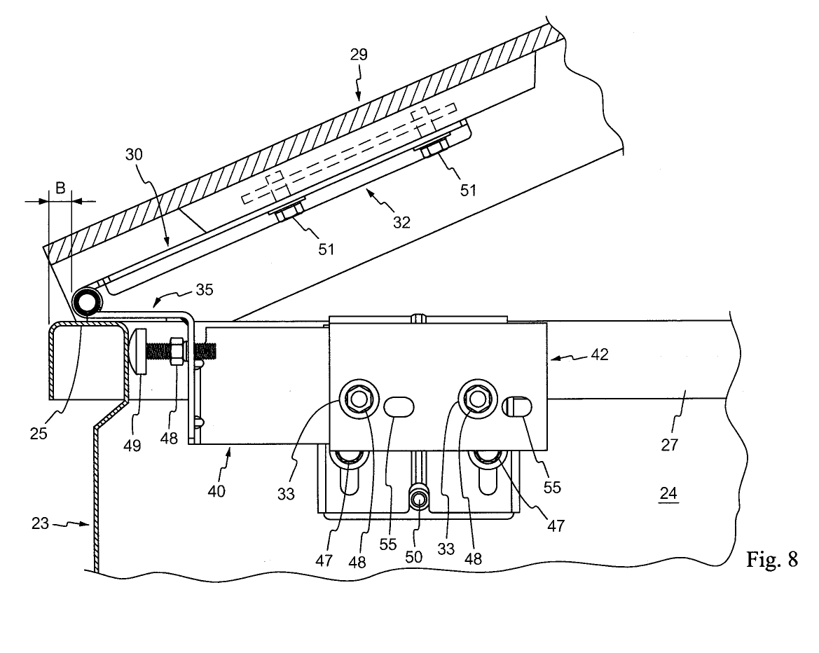

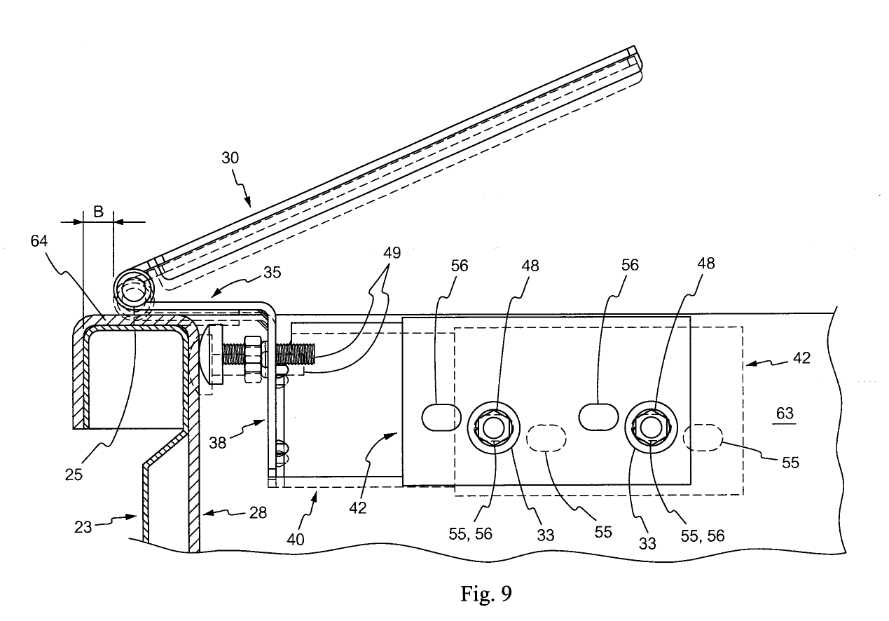

The mounting assembly further comprises the cover plate 42 for use with the right hinge 30, as shown in FIG. 3. The cover plate 42 includes the upper protrusion 60 extending therefrom and includes the lower protrusion 61 extending therefrom in the same direction as the upper protrusion. The cover plate 42 includes two lower holes 55 and two upper holes 56, wherein the upper holes 56 are located in the higher position than the lower holes 55 for the distance X of at least equal to the thickness of the bed liner, as shown in FIG. 7. The thickness of the bed liner 28 is represented by the distance Y. The lower holes 55 are used in the attachment to the pickup truck mounted with the bed liner 28. The upper holes 56 are used in the attachment to the pickup truck 20 without the bed liner 28. The reason that the distance X is at least equal to the thickness of the bed liner 28 is described as follows. In case the distance X is equal to the thickness of the bed liner 28, during the mounting of the bed liner 28 using the lower holes 55, the front plate 35 rests in direct contact with the upper edge 64 of the front bed liner wall 62 as shown in FIGS. 7 and 9. During the mounting without the bed liner 28 using the upper hole 56, the front plate 35 will rest in direct contact with the upper edge 25 of the front truck bed wall 23 as shown in FIGS. 8 and 9. In case the distance X is greater than the thickness of the bed liner 28 and the bed liner 28 installed which using the lower hole 55, the front plate 35 rests above the upper edge 64 of the front bed liner wall 62 for a certain distance. It can be seen that the mounting is possible. However, it may be necessary to provide additional members to prevent the permeation of the water and to provide efficient usage.

The mounting assembly further comprises the cover plate 42L for use with the left hinge 31, as shown in FIG. 4. The cover plate 42L includes the upper protrusion 60L extending therefrom and includes the lower protrusion 61L extending therefrom in the same direction as the upper protrusion. The cover plate 42L includes two lower holes 55L and two upper holes 56L, wherein the upper hole 56L is located in the higher position than the lower hole 55L for the distance of at least equal to the thickness of the bed liner 28. The lower hole 55L is attached to the pickup truck 20 mounted with the bed liner 28. The upper hole 56L is attached to the pickup truck 20 without the bed liner 28. The reason that the upper hole 56L is higher than the lower hole 55L for the size of at least equal to the thickness of the bed liner 28 is the same as that of the cover plate 42 as described above.

The lateral plate 40 of the right hinge 30, as shown in FIG. 3, is attached to the connector 46 by engaging two notches 41 of the lateral plate to the threaded shaft 52 of the connector 46. The cover plate 42 is then mounted to the lateral plate 40 by coupling the upper protrusion 60 to the upper edge of lateral plate 40 and coupling the lower protrusion 61 to the lower edge of the lateral plate 40 and engaging the lower hole 55 or the upper hole 56 of the cover plate with the threaded shaft 52 of the connector. The nut 48 accompany anti-loosing means is then tightened, which, in the present invention, the spring washer 67 is used for anti-loosing. The cover plate 42 prevents the lateral plate 40 from vertically sliding. That is, if the cover plate 42 is not provided but the lateral plate 40 is engaged with the threaded shaft 52 using only the nut 48, the notch 41 of the lateral plate may be vertically slidable. On the other hand, if the cover plate 42 is engaged before the nut is fastened, the cover plate 42 is thus tightened to the threaded shaft 52. This will prevent the cover plate 42 from moving up and down or rotating due to the fact that the upper protrusion 60 and lower protrusion 61 will retain the lateral plate 40 in the fixed position. The upward and downward movement is therefore impossible.

The lateral plate 40L of the left hinge 31, as shown in FIG. 4, is attached to the connector 46 by engaging two notches 41L of the lateral plate to the threaded shaft 52 of the connector 46. The cover plate 42L is then mounted to the lateral plate 40L by coupling the upper protrusion 60L to the upper edge of lateral plate 40L and coupling the lower protrusion 61L to the lower edge of the lateral plate 40L and engaging the lower hole 55L or the upper hole 56L of the cover plate with the threaded shaft 52 of the connector. The nut 48 accompany anti-loosing means is then tightened.

FIG. 9 shows the comparison of the position of the right hinge 30 in case of being mounted to the truck bed 22 with the bed liner 28 as indicated by the solid line compared with the right hinge 30 mounted to the truck bed 22 without the bed liner 28 as indicated by the dotted line. It can be seen that, when the bed liner 28 is not mounted, the front plate 35 of the hinge will rest against the upper edge 25 of the front truck bed wall. On the other hand, when the bed liner 28 is mounted, the front plate 35 of the hinge will rest against the upper edge 64 of the front bed liner wall. But in both cases, the distance from the hinge to the front edge of the truck bed 22 as shown by the distance B must be the same. This will allow the tonneau cover 29 to tightly cover the truck bed 22. In case the hinge is mounted in the position away from the front edge of the truck bed 22 by the distance of greater than the distance B, the rear edge of the tonneau cover 29 will be located beyond the truck bed 22. However, in case the hinge is mounted in the position away from the front edge of the truck bed 22 by the distance of less than the distance B, the rear edge of the tonneau cover 29 will be located inwardly next to rear of the truck bed 22. That is, the tonneau cover 29 is not tightly closed. It can be seen that, the mounting method of the hinge for the tonneau cover 29 and the mounting assembly according to the present invention can be changed from the case where the pickup truck 20 is mounted with or without the bed liner 28 by only properly selecting the upper hole or the lower hole of the cover plate 42.

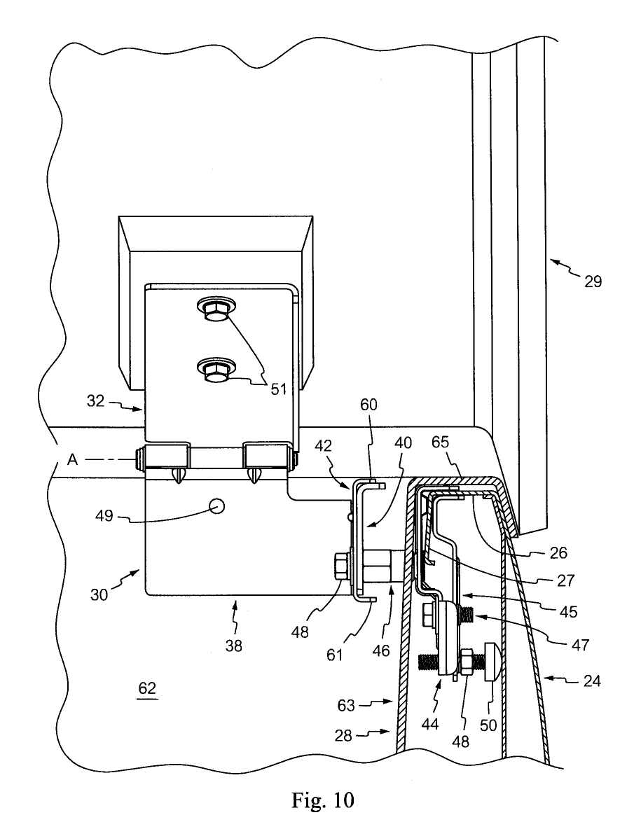

The bracket 50, as shown in FIG. 3, is used with the first clamping device. The bracket 50 is placed in the position that abuts the right truck bed wall 24, as shown in FIG. 10. This will allow the outer plate 44 to rest in the substantially vertical position. The bracket 50 is used in connection with the nut 48 and the threaded hole 54.

The bracket 50, as shown in FIG. 4, is used with the second clamping device. The bracket 50 is placed in the position that abuts the left truck bed wall. This will allow the outer plate 44 to rest in the substantially vertical position. The bracket 50 is used in connection with the nut 48 and the threaded hole 54.

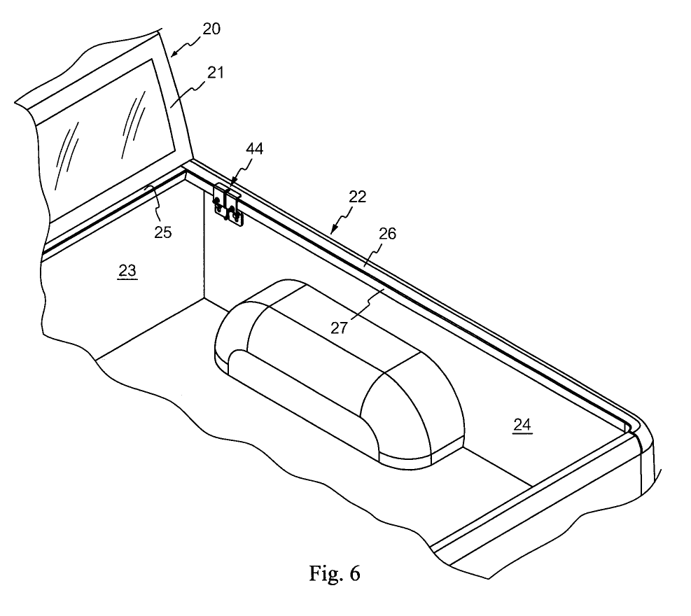

The hinge for tonneau cover 29 and mounting assembly according to the present invention comprises the mounting method in case the pickup truck is mounted with the bed liner as follows. In case the truck bed 22 has already been mounted with the bed liner 28, first, the installer preferably must remove the bed liner 28 from the truck bed 22. The installer then preferably drills the hole 66 in the predetermined position, as shown in FIG. 5, at the right bed liner wall 63 and the left bed liner wall. The installer then mounts the clamping device comprising the outer plate 44 and the inner plate 45, as shown in FIGS. 3 and 4, to the downward edge on the left and the right sides of the truck bed 22 in the position close to the front of the truck bed 22. This can be done by inserting the bolt 47 through the spring washer 67, the washer 33, and the hole 57 at the outer plate. The bolt 47 is then fastened to the threaded hole 58 at the inner plate 45. This will allow the outer plate 44 to exert a force to the inner plate 45 with the downward edge resting therebetween. This will allow the outer plate 44 to be attached to the truck bed 22 wherein FIG. 6 shows the first clamping device mounted to the right truck bed wall 24.

The bed liner 28 is then placed on the truck bed 22 where the position of the drilled hole 66 corresponds to the threaded shaft 59. The connector 46 is to be mounted to the outer plate 44 by inserting the connector 46 through the hole 66 at the lateral bed liner wall. The connector 46 is then fastened to the threaded shaft 59 of the outer plate 44. The right hinge 30 and left hinge 31 are to be mounted to the tonneau cover 29 by inserting the bolt 51 through the spring washer 67, the washer 33, and the hole 34 of the right hinge and fastening to the threaded hole at the tonneau cover 29. The bolt 51 is inserted through the spring washer 67, the washer 33, and the hole 34L of the left hinge 31 and then fastened to the threaded hole at the tonneau cover 29.

The right hinge 30 and left hinge 31 are to be mounted to the truck bed 22. In case of the mounting of the right hinge 30, the installer must engage the notch 41 to the threaded shaft 52. The cover plate 42 is then engaged with the lateral plate 40 by engaging the lower hole 55 to the threaded shaft 52. The washer 33 and the spring washer 67 are then mounted and fastened by the nut 48. Once the mounting is completed, the result will be as shown in FIGS. 7 and 10. The mounting method of the left hinge 31 is done is the similar way. As can be seen from FIG. 10, the upper edge 65 of the right bed liner wall rests on the outer plate 44.

In case the truck bed 22 is not mounted with the bed liner 28, the mounting steps of the hinge for the tonneau cover 29 and the mounting assembly are similar to the steps as previously described, but the steps related to the bed liner 28 are omitted and, in the mounting steps for the cover plate, the installer must engage the upper holes 56, 56L to the threaded shaft 52.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A hinge for a tonneau cover and a mounting assembly comprising:
a right hinge, a left hinge, four connectors, a first clamping device, and a second clamping device;
wherein the first clamping device is attached to a right edge of a truck bed and the second clamping device is attached to a left edge of the truck bed;
two of the connectors being attached to the first clamping device and two of the connectors being attached to the second clamping device;
the right hinge comprising an upper plate having a first end and a second end, the first end of the upper plate being attached to the tonneau cover and the second end being rotatably attached to a first end of a front plate;
the front plate having the first end and a second end, the first end of the front plate being rotatably attached to the upper plate, the second end of the front plate including a downward plate extending therefrom, wherein during mounting the first end of the front plate rests over an upper edge of a front truck bed wall;
the downward plate extending from the front plate in a downward direction, the right edge of the downward plate including a lateral plate extending therefrom; and
the lateral plate extending from the downward plate in a direction toward a rear end of the truck after being assembled, wherein the lateral plate is attached to the two connectors attached to the first clamping device;
the left hinge comprising an upper plate having a first end and the second end, wherein the first end of the upper plate of the left hinge is attached to the tonneau cover and the second end of the upper plate of the left hinge is rotatably attached to the first end of the front plate;
the front plate having a first end and a second end, wherein the first end is rotatably attached to the upper plate and the second end includes a downward plate extending therefrom, wherein during mounting the first end rests over the upper edge of front truck bed wall;
the downward plate extending from the front plate in the downward direction, the left edge of the downward plate includes a lateral plate extending therefrom; and
the lateral plate extending from the downward plate in the direction toward the rear end of the truck after being assembled, wherein the lateral plate is attached to the two connectors attached to the second clamping device.

2. The hinge for a tonneau cover and mounting assembly according to claim 1, further comprising:
a bracket for use with the right hinge, the bracket being adjustably attached to the downward plate of the right hinge, wherein during mounting one end of the bracket abuts the front truck bed wall; and
a bracket for use with the left hinge, the bracket being adjustably attached to the downward plate of the left hinge, wherein during mounting one end of the bracket abuts the front truck bed wall.

3. The hinge for a tonneau cover and mounting assembly according to claim 1, wherein
the lateral plate of the right hinge includes two notches extending from the lower edge of the lateral plate;
the lateral plate of the left hinge includes two notches extending from the lower edge of the lateral plate;
the outer plate of the first clamping device including two threaded shafts;
the outer plate of the second clamping device including two threaded shafts;
each connector comprising two ends, one end being the threaded shaft and the other end including the threaded hole, wherein during mounting the threaded hole of the connector is fastened to the threaded shaft of the outer plate;
the mounting assembly further comprises a cover plate for use with the right hinge, wherein the cover plate includes a upper protrusion extending therefrom and includes a lower protrusion extending therefrom in the same direction as the upper protrusion, the cover plate including two lower holes and two upper holes, wherein the upper holes are located in a higher position than the lower holes for the distance of at least equal to the thickness of the bed liner, the lower holes being used in the attachment to the pickup truck mounted with the bed liner, the upper holes being used in the attachment to the pickup truck without the bed liner;
the mounting assembly further comprises a cover plate for use with the left hinge, wherein the cover plate includes a upper protrusion extending therefrom and includes a lower protrusion extending therefrom in the same direction as the upper protrusion, the cover plate including two lower holes and two upper holes, wherein the upper holes are located in a higher position than the lower holes for the distance of at least equal to the thickness of the bed liner, the lower holes being used in the attachment to the pickup truck mounted with the bed liner, the upper holes being used in the attachment to the pickup truck without the bed liner;
the lateral plate of the right hinge being attached to the connector by engaging two notches of the lateral plate to the threaded shaft of the connector, the cover plate then being mounted to the lateral plate of the right hinge such that the upper protrusion couples to the upper edge of lateral plate and the lower protrusion couples to the lower edge of the lateral plate and the lower holes or the upper holes of the cover plate engage with the threaded shaft of the connector, and the nut accompany anti-loosing means being fastened.
the lateral plate of the left hinge being attached to the connector by engaging two notches of the lateral plate to the threaded shaft of the connector, the cover plate then being mounted to the lateral plate of the left hinge such that the upper protrusion couples to the upper edge of lateral plate and the lower protrusion couples to the lower edge of the lateral plate and the lower holes or the upper holes of the cover plate engage with the threaded shaft of the connector, and the nut accompany anti-loosing means being fastened.
